(19) United States
(12) Patent Application Publication
(10) Pub. No.: US 2020/0052345 A1
(43) Pub. Date: Feb. 13, 2020

(54) Rapid Thermal Annealing of Cathode-Electrolyte Interface for High-Temperature Solid-State Batteries

(71) Applicant: University of Maryland Office of Technology Commercialization, College Park, MD (US)

(72) Inventors: Liangbing HU, Potomac, MD (US); Boyang Liu, Columbia, MD (US); Kun Fu, College Park, MD (US); Chengwei Wang, College Park, MD (US)

(21) Appl. No.: 16/514,994

(22) Filed: Jul. 17, 2019

Related U.S. Application Data
(60) Provisional application No. 62/699,541, filed on Jul. 17, 2018.

(51) Int. Cl. H01M 10/39; H01M 4/62; H01M 10/0525; H01M 8/0232; H01M 10/615

(52) U.S. Cl. CPC H01M 10/3918; H01M 4/625; H01M 2008/1293; H01M 8/0232; H01M 10/615; H01M 10/0525

(57) ABSTRACT

Cathode-electrolyte constructs, including such constructs in electrochemical systems, such as batteries are discussed. The cathode-electrolyte constructs can include a solid state electrolyte (SSE) and a cathode that includes particulate cathode material and the cathode conformally contacts the solid state electrolyte. Also discussed are methods of making cathode-electrolyte constructs and batteries.

### CROSS REFERENCE TO RELATED APPLICATIONS

This non-provisional application claims the benefit of U.S. provisional application No. 62/699,541 filed on Jul. 17, 2018, which is incorporated herein by reference in its entirety.

### NOTICE OF GOVERNMENT FUNDING

This invention was made with government support under contract DEEE0006860 awarded by the DOE. The government has certain rights in this invention.

### TECHNICAL FIELD

This disclosure relates to materials and methods of manufacture that can in some embodiments reduce interfacial impedance in solid-state electrolyte systems, such as solid-state batteries.

### BACKGROUND

Various electrochemical systems, such as batteries, utilize active materials to take up, give up and transfer ions during charge and discharge operation. In some embodiments, an electrolyte, such as a solid-state electrolyte (SSE), can provide an ion conduction path between one portion of the electrochemical system to another, such as from a cathode to an anode or from an anode to a cathode, with the cathode comprising cathode active material which receives the ions conducted from the anode active material of the anode. For such systems, it can be desirable to have low impedance to ion conduction.

Various contributors to impedance to ion conduction can include interfacial impedance among other contributors. Frequently, interfacial impedance can be described as a resistance to ion conduction at the interface of an active material used in a cathode or an anode to an electrolyte material, such as a solid-state electrolyte material.

Causes of increased interfacial impedance can include poor contact between an active material and the SSE, reactions involving active material and/or SSE, poor distribution of active material along SSE, etc.

### SUMMARY

In a first aspect disclosed herein, a cathode-electrolyte construct is provided. The cathode-electrolyte construct comprises a solid state electrolyte; and a cathode comprising particulate cathode material, the cathode conformally contacts the solid state electrolyte.

In a first embodiment of the first aspect, the particulate cathode material comprises a first and a second material, the first and second materials different from one another, and particles of the first material are intermixed with particles of the second material contact the solid state electrolyte.

In a second embodiment of the first aspect, the particulate cathode material comprises a first and a second material, the first and second materials different from one another, and particles of the first material are intermixed with particles of the second material contact the solid state electrolyte and particles of the first material contact the solid state electrolyte and particles of the second material contact the solid state electrolyte.

In a third embodiment of the first aspect, the particulate cathode material comprises a first and a second material, the first and second materials different from one another, and particles of the first material are intermixed with particles of the second material contact the solid state electrolyte and the first material is an electrically conductive material and the second material comprises a cathode active material.

In a fourth embodiment of the first aspect, the particulate cathode material comprises a first and a second material, the first and second materials different from one another, and particles of the first material are intermixed with particles of the second material contact the solid state electrolyte and the first material is an electrically conductive material and the second material comprises a cathode active material and conductive material comprises a carbon material.

In a fifth embodiment of the first aspect, the particulate cathode material comprises a first and a second material, the first and second materials different from one another, and particles of the first material are intermixed with particles of the second material contact the solid state electrolyte and the first material is an electrically conductive material and the second material comprises a cathode active material and conductive material comprises a carbon material and the carbon material is carbon nanotubes.

In a sixth embodiment of the first aspect, the particulate cathode material comprises a first and a second material, the first and second materials different from one another, and particles of the first material are intermixed with particles of the second material contact the solid state electrolyte and the first material is an electrically conductive material and the second material comprises a cathode active material and the cathode active material is selected from the group consisting of layered oxide, spinel, olivine, sulfur, metal-sulfur compounds, lithium-containing sulfides, and sulfur-carbon complexes.

In a seventh embodiment of the first aspect, the particulate cathode material forms a layer on the solid state electrolyte, the layer having a thickness of 0.1-250 μm or 0.1-500 μm.

In an eighth embodiment of the first aspect, conformal contact between the cathode and the solid state electrolyte is substantially free of voids.

In a second aspect disclosed herein, a solid state batter is provided. The solid state battery comprising: a cathode-electrolyte construct that comprises a solid state electrolyte; and a cathode comprising particulate cathode material, the cathode conformally contacts the solid state electrolyte; a cathode current collector; an anode; and an anode current collector, wherein the cathode current collector is in electrical communication with the particulate cathode material, the anode is in ionic communication with the solid state electrolyte, and the anode current collector is in electrical communication with the anode, and the solid state battery is configured for ions to flow from the anode, through the solid state electrode to the particulate cathode material when electrons flow through an external circuit from the anode current collector to the cathode current collector.

In a first embodiment of the second aspect, the cathode current collector contacts the particulate cathode material, and the anode contacts both the solid-state electrolyte and the anode current collector.

In a third aspect disclosed herein, a method of making a cathode-electrolyte construct that comprises a solid state electrolyte; and a cathode comprising particulate cathode material, the cathode conformally contacts the solid state electrolyte is provided. The method of making the cathode-electrolyte construct comprising applying the particulate cathode material to the solid-state electrolyte to form a cathode-electrolyte preform; and heating the cathode-electrolyte preform to a temperature exceeding a sintering temperature of a component of the particulate cathode material for a period of time that is less than a time necessary for a volume average particle size in the cathode-electrolyte construct to be more than 10% larger in a diameter than a volume average particle size in the cathode-electrolyte preform; or that is less than a time necessary for reaction or a change of phase of a component of the cathode or electrolyte does not extend beyond 0.5 nm of the interface, or to increase the impedance of the cathode-electrode construct by more than 5% or 8% or 10% of the impedance as compared to the same composition cathode-electrode construct with a conformal interface that has not experienced the reaction or change of phase, and cooling the heated cathode-electrolyte preform to yield the cathode-electrolyte construct.

In a first embodiment of the third aspect, the first material is an electrically conductive material and the second material comprises a cathode active material.

In a second embodiment of the third aspect, the first material is an electrically conductive material and the second material comprises a cathode active material.

In a third embodiment of the third aspect, the first material is an electrically conductive material and the second material comprises a cathode active material and the electrically conductive material comprises a carbon material.

In a fourth embodiment of the third aspect, the first material is an electrically conductive material and the second material comprises a cathode active material and the electrically conductive material comprises a carbon material and the carbon material is carbon nanotubes.

In a fifth embodiment of the third aspect, the first material is an electrically conductive material and the second material comprises a cathode active material and the cathode active material is selected from the group consisting of layered oxide, spinel, olivine, sulfur, metal-sulfur compounds, lithium-containing sulfides, and sulfur-carbon complexes.

In a sixth embodiment of the third aspect, a volume average size of the particulate cathode material does not change more than 10% after cooling compared to before heating.

In a seventh embodiment of the third aspect, the cathode-electrolyte preform is heated to a temperature that is within a range of 0.5-0.9× a melting point in Celsius of a component of the cathode or to a temperature greater than 345° C.

In an eighth embodiment of the third aspect, a time for heating, cooling and optionally holding at an elevated temperature is less than 60 seconds.

In a fourth aspect disclosed herein, a high-temperature battery is provided. The high-temperature battery comprising a solid state electrolyte; a solid cathode comprising a solid cathode active material and a cathode current collector; an anode comprising a captive anode active material and an anode current collector, wherein the high temperature battery is configured to operate at a temperature in of 100° C. or higher, or 90° C. or higher.

In a first embodiment of the fourth aspect, the captive anode material is a solid metal held on an anode side of the solid state electrolyte.

In a second embodiment of the fourth aspect, the captive anode material is a metal contained in pores of the solid state electrolyte.

In a third embodiment of the fourth aspect, the captive anode material is a metal contained in pores of the solid state electrolyte and the metal is a molten metal contained in pores of the solid state electrolyte.

In a fourth embodiment of the fourth aspect, the solid-state electrolyte comprises a dense portion and a first porous portion.

In a fifth embodiment of the fourth aspect, the solid state electrolyte further comprises a second porous portion, wherein the first and second porous portions are each in contact with the dense portion.

In a sixth embodiment of the fourth aspect, the solid state electrolyte is a lithium conducting solid state electrolyte, the anode active material is lithium metal and the cathode active material is a lithium storing material.

In a seventh embodiment of the fourth aspect, the solid state electrolyte is garnet LLCZNO or garnet Li_{6.75}La_{2.75}Ca_{0.25}Zr_{1.5}Ta_{0.5}O₁₂ or garnet Li_{6.75}La₃Zr_{1.75}Ta_{0.25}O₁₂, the anode active material is lithium metal, and the cathode active material is V₂O₅.

In a fifth aspect disclosed herein, a method of operating a battery is provided. The method of operating a battery comprising exposing a battery to a temperature in excess of 100° C.; discharging or charging the battery, wherein discharging the battery comprises the steps of: oxidizing an anode active material at an anode to release one or more electrons and form a cation; conducting the cation from the anode active material into a solid-state electrolyte; conducting the cation through the solid-state electrolyte to a cathode; and accepting one or more electrons from the anode into the cation at the cathode to form a reduced material; and charging the battery comprises the steps of removing one or more electrons from the reduced material at the cathode to form the cation; conducting the cation from the cathode active material into the solid-state electrolyte; conducting the cation through the solid-state electrolyte to the anode; and adding the one or more electrons from the cathode into the cation at the anode to form the anode active material. [0036]1 In a first embodiment of the fifth aspect, the solid state electrolyte is a lithium conducting solid state electrolyte, the anode active material is lithium metal and the cathode active material is a lithium storing material.

In a second embodiment of the fifth aspect, the solid state electrolyte is lithium-conductive garnet or garnet LLCZNO or garnet Li_{6.75}La_{2.75}Ca_{0.25}Zr_{1.5}Ta_{0.5}O₁₂ or garnet Li_{6.75}La₃Zr_{1.75}Ta_{0.25}O₁₂ or combinations thereof, and/or the anode active material is lithium metal, and/or the cathode active material is V₂O₅.

In a third embodiment of the fifth aspect, the battery is exposed to the temperature in excess of 100° C. while charging or discharging the battery.

In a fourth embodiment of the fifth aspect, the battery is exposed to a temperature in excess of 150° C., 200° C., 250° C., 300° C., 350° C. or 400° C.

In a fifth embodiment of the fifth aspect, the battery is exposed to a temperature in excess of 150° C., 200° C., 250° C., 300° C., 350° C. or 400° C. while discharging the battery.

### BRIEF DESCRIPTION OF THE DRAWINGS

FIG. 1 shows a schematic of an embodiment of a solid-state battery structure and the effect of rapid thermal annealing.

FIG. 2 shows a schematic, SEM and graph for an embodiment of a solid-state battery and the effect of rapid thermal annealing.

FIG. 3 shows the results of rapid thermal annealing on an embodiment of a cathode-SSE interface.

FIG. 4 shows characteristics of an embodiment of a cathode-SSE interface not treated with rapid thermal annealing.

FIGS. 5A-G show an embodiment of rapid thermal annealing and its effect on an embodiment of garnet SSE and cathode.

FIGS. 6A-F show characteristics of an embodiment of a cathode/garnet/cathode symmetric cell that has been treated with rapid thermal annealing.

FIGS. 7A-G show performance characteristics of Li metal symmetric cells and full cells treated with rapid thermal annealing and a demonstration of a flammability test of battery with polymer separator compared to an all-solid-state battery.

### DETAILED DESCRIPTION

In the following description, numerous specific details are set forth to clearly describe various specific embodiments disclosed herein. One skilled in the art, however, will understand that the presently claimed invention may be practiced without all of the specific details discussed below. In other instances, well known features have not been described so as not to obscure the invention.

Solid state electrolyte (SSE), solid-state batteries and other electrochemical devices can be desirable in various applications due to a reduced risk of corrosion, leakage, fire or explosion over a range of applications. In addition, SSE and solid-state batteries and electrochemical systems can have further advantages of physical strength, dimensional stability and high temperature operational characteristics over other types of systems.

For situations of high temperature operation of electrochemical systems and batteries, there can be additional requirements such as the components being thermally stable and being able to function properly at high temperatures. Nonsolid-state batteries can have high-temperature safety issues such as thermal runaway, which can at least in some embodiments be attributed at least in part to the properties of at least some liquid organic electrolytes, such as low boiling points and high flammability. However, a solid-state battery (including batteries that are entirely solid-state), such as one using a thermally stable garnet solid-state electrolyte, a metal anode, such as lithium metal, and a solid state cathode active material, such as a V₂O₅ cathode, can be made without a liquid organic electrolyte and in some designs can operate well at 100° C.

Batteries that can maintain excellent electrochemical performance at high temperatures can be useful for applications in the oil and gas industries, the aerospace sectors, and the military. Some of these high-temperature batteries can be divided into two subcategories, those with and those without intrinsic thermal stability. Some batteries without intrinsic thermal stability can benefit from cooling systems when faced with high-temperature environments. Some batteries with intrinsic thermal stability can be used without cooling systems and frequently are able to operate at elevated temperatures and extreme environments. High-temperature batteries can be more energy efficient and/or safer under specific conditions, which can make them more suitable for a myriad of high-temperature applications.

However, a solid state battery (or electrochemical system) can have elevated interfacial impedance between the solid-state electrolyte and the cathode. As presented herein, a rapid thermal annealing method can be used to reduce the interfacial impedance at the interface of the solid-state electrolyte and the cathode. As demonstrated herein, the rapid thermal treatment can reduce the incidence of voids between the two materials and increase the interfacial contact of the two materials. In some embodiments, the rapid thermal annealing can melt the cathode and form a continuous contact. In some embodiments, the rapid thermal annealing can utilize phenomena other than or in addition to melting, to achieve the reduction of interfacial impedance and/or increase in interfacial contact and/or reduction in the incidence of interfacial voids. Without wishing to be bound by theory, such mechanisms can include expansion/contraction, differential expansion/contraction, softening of materials due to temperature, plastic flow, elastic flow, changes in surface energy of particles, changes in the wetting characteristics of the materials with temperature, etc.

In one embodiment described herein, the resulting interfacial impedance between a solid electrolyte and a V₂O₅ cathode was decreased from 2.5×10⁴ to 71 Ω·cm² at room temperature and from 170 to 31 Ω·cm² at 100° C. Additionally, the diffusion impedance in the V₂O₅ cathode significantly decreased as well. Accordingly, this disclosure demonstrates that solid-state batteries, including high temperature solid-state batteries, and other electrochemical systems using solid state electrolytes, such as garnet solid electrolytes, can have reduced contact resistance between a solid state electrolyte and a solid cathode active material, such as V₂O₅ cathode active material, while also achieving improved electrochemical system safety (e.g. battery safety) and/or performance.

In some situations, it might be possible to utilize batteries, such as high-temperature batteries, that utilize electrolytes such as molten salts and polymer electrolytes with improved thermal stability. However, molten salt electrolytes have similar leakage concerns as conventional liquid organic electrolytes at high temperatures and polymer electrolytes tend to have poor mechanical strength at elevated temperatures, which can cause hazardous short-circuiting issues during operation.

In comparison, solid-state electrolyte (SSE), such as ceramic solid-state electrolyte, can provide an alternate route for addressing safety concerns of high-temperature battery operation due to its high thermal and electrochemical stability. Moreover, ceramic SSEs can have increased ionic conductivity at elevated temperatures, which can lead to enhanced performance relative to room temperature operation. Therefore, it can be desirable to select ceramic SSEs to meet the performance requirements and operating temperature ranges for specific applications. One embodiment of a ceramic SSE is garnet Li₇La₃Zr₂O₁₂ which has benefits of high thermal stability, high ionic conductivity, and good electrochemical stability against lithium (Li) metal electrodes. In one embodiment of a high-temperature solid-state lithium metal battery utilizing thermally stable Li₇La_{2.75}Ca_{0.25}Zr_{1.75}Nb_{0.25}O₁₂ (LLCZNO) garnet SSE or Li_{6.75}La_{2.75}Ca_{0.25}Zr_{1.5}Ta_{0.5}O₁₂ garnet SSE or Li_{6.75}La₃Zr_{1.75}Ta_{0.25}O₁₂ garnet SSE and V₂O₅ cathode to operate at 100° C. with reliable safety and stable cycling performance, in order to achieve conformal cathode/garnet contact without the increased risk of parasitical reactions associated with long sintering time, a rapid thermal annealing technique to treat the cathode and garnet interface in only a few seconds was used, as described herein. With this interface treatment, the cathode/garnet interfacial impedance can be significantly decreased and battery cycling stability improved. In addition, the rapid thermal annealing method described herein can be advantageous over other methods of reducing interfacial impedance and improving battery cycling stability, such as strategies of adding polymer/liquid electrolyte in the cathode in that the cathode of the battery treated by rapid thermal annealing can be totally solid-state and all of the battery components can have high thermal stability. Therefore, batteries constructed using the rapid thermal annealing method can have improved stability and greater safety for operation at temperatures higher than 100° C. as well as at other temperatures.

One challenge associated with SSE relates to the quality and continuity of solid-solid interfaces between the rigid SSE and electrodes, which can result in high and variable interfacial impedance, such as batch to batch variability and with variability over time. One approach to address high interfacial impedance between SSE and active metal at the anode is by applying metal or metal oxide interlayers at the interface. The interlayers can improve the contact between SSE and active metal, and result in significantly decreased interfacial impedance.

Various techniques can also be used for addressing interfacial impedance problems between the cathode and the SSE, such as co-sintering, thin film deposition, embedding, etc., but such techniques can require long processing time and/or high-temperature sintering processes, which can, for example, cause undesirable side reactions between the cathode and SSE material. Accordingly, additional methods are desired for reducing interfacial impedance, reducing variability and improving stability of the cathode-SSE interface.

In one embodiment of a cathode-SSE interface, the interface can be made by a rapid thermal annealing process of cathode material or cathode precursor material applied to a SSE or a SSE precursor. FIG. 1 shows a schematic of a solid state battery 1 where a SSE 11 has an anode 12 on one side of the SSE 11 and a cathode 14 on an opposite side of the SSE 11. (In some embodiments, the locations of anode 12, cathode 14 and SSE 11 can be somewhat different, such as with the anode 12 and cathode 14 on adjacent surfaces of the SSE 11 or on the same surface of the SSE 11. In some embodiments of an electrochemical system, the anode 12 or cathode 14 can be absent, and/or additional anode(s) 12 or cathode(s) 14 can be present.

In one embodiment of a method of making a cathode-SSE interface, such as that shown in FIG. 1, an electrode 16 can be applied to an electrolyte (such as a solid-state electrolyte 11) followed by rapid thermal annealing which results in the electrode 16 conformally coating the electrolyte 11 resulting a conformal interface 18 in the electrode-electrolyte construct (e.g. cathode-electrolyte construct) 26. The interface 20 shown in the cathode-electrolyte preform 24 (prior to rapid thermal annealing) the material illustrates voids 22 at the interface which can adversely affect the interfacial impedance, such as by increasing the resistance or variability of the interface or by reducing stability of the interface. As can be seen in FIG. 1, rapid thermal annealing causes the interface to go from an interface of being discontinuous to a conformal interface which is more continuous or substantially continuous or completely continuous, with one material following the shape and contours of the other material with a substantial decrease in the number of voids and an increase in the number of and/or size of contact points between the SSE and the electrode.

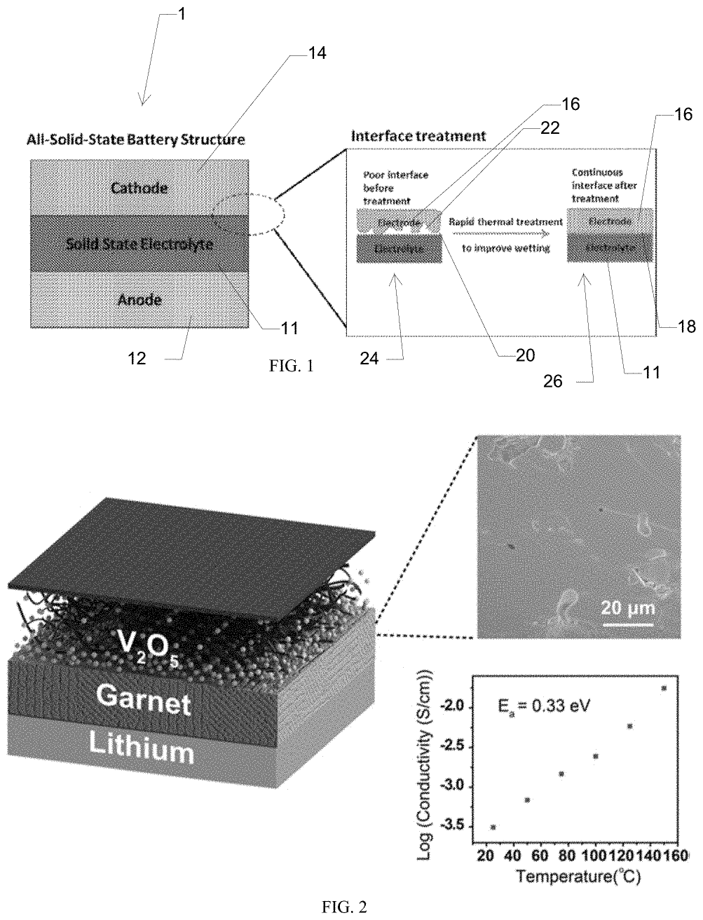

FIG. 2 (left side) shows the structure of an embodiment of a solid-state battery with Li metal anode and garnet SSE. V₂O₅ was selected as the cathode active material because of its high thermal stability with a melting temperature of 690° C. and decomposition temperature of 1750° C. Carbon nanotubes (CNT) were mixed with V₂O₅ in the cathode for electron conduction. FIG. 2 (upper right) is a crosssectional scanning electron microscope (SEM) image of garnet SSE. It exhibits the dense structure of garnet SSE, which enables the garnet SSE to have high ionic conductivity and stability at high temperatures, while preventing Li metal dendrite penetration during cycling. The garnet SSE has a high ionic conductivity of 3.7×10-4 S/cm at room temperature and the ionic conductivity increases exponentially with temperature to 2.4×10-3 S/cm at 100° C. (FIG. 2, lower right). The high conductivity at elevated temperatures provides high energy density and efficiency for the high-temperature battery.

Construction of a high-temperature battery, such as a battery that can be exposed to an elevated temperature up to 80° C., 100° C., 130° C., 150° C., 180° C., 200° C., 250° C., 300° C., 350° C., 400° C., 450° C., 500° C., 550° C., 600° C., 650° C. or higher can include use of a solid-state electrolyte combined with a solid cathode material is a part of the cathode and an anode material that is captive in the anode.

Solid cathode materials can comprise solid cathode active materials, such as materials that are capable of accepting a cation being conducted through the solid-state electrolyte and participating in a charge transfer reaction with the cation, and which is a solid at the temperature of interest. One embodiment of a cathode active material is V₂O₅, which has a melting point of 690° C., and therefore can be used in batteries up to 690° C. However, practical considerations, such as changes in structural strength and the possibility of side reactions, changes in crystal form and changes in particle size at elevated temperatures can result in a practical limitation somewhat below the melting point. However, additional materials that are suitable for cathode active material at elevated temperatures can be used as well, at temperatures exceeding that of V₂O₅. It is also noted that for many solid materials including those suitable for cathode active material, the ionic conductivity and electronic conductivity of the material increases with increasing temperature (see, e.g. FIG. 2.) Accordingly, a high-temperature battery, in some embodiments, might experience impaired operation at room temperature or temperatures that are only moderately elevated.

In some preferred embodiments, the cathode material can also comprise an electrically conductive material, preferably a nonmetallic electrically conductive material, such as a form of carbon such as graphite, carbon black, hard carbon or carbon nanotubes.

Solid-state electrolytes, such as those for use in a high-temperature battery (or other electrochemical system) can be a ceramic or other material that is sufficiently stable at the temperatures of interest. Stability can in various embodiments be reflected in the melting point, sintering temperature, phase transition temperature (e.g. crystal form transition temperature), etc. In addition, as with solid cathode active material, the ionic conductivity of solid-state electrolyte material can increase with increasing temperature. However, as with solid cathode active material, impaired operations might be experienced as less elevated temperatures. Specific materials can include garnet materials including, for example those described herein with a preferred formulation being LLCZNO or garnet Li_{6.75}La_{2.75}Ca_{0.25}Zr_{1.5}Ta_{0.5}O₁₂ or garnet Li_{6.75}La₃Zr_{1.75}Ta_{0.25}O₁₂.

In some embodiments, a solid-state electrolyte can comprise or consist of a dense layer. Such a dense layer can have low porosity, and can in some embodiments provide some protection against dendrite formation. In some embodiments, a solid-state electrolyte can comprise one or more porous regions associated with a dense region, such as with one or more porous regions each contacting the dense region. For example, there can be one porous region contacting the dense region, or there can be two porous regions, each on an opposite side of the dense region, or two porous regions each contacting the same face of the dense region. In some embodiments, the cathode material, such as the cathode active material can be embedded into at least a portion of the solid-state electrolyte, such as being located within pores of a portion of the solid-state electrolyte.

In some embodiments, the dense region can be thin and define a conduction path that is less than 10, 10-20, 20-30, 30-40, 40-50, 50-70, 70-100, 100-200, 200-400, 400-600, 600-800, 800-1000 nm or more long.

Anode active material can be any suitable material that can be oxidized and reduced within the appropriate portions of the electrochemical system (e.g. battery) and can be conducted by the solid-state electrolyte in the ion form. In some embodiments, the anode active material can be a solid. In some embodiments, the anode active material can be a metal. In some embodiments, the anode active material can be a solid metal. In preferred embodiments, the anode active material can be captive within the anode region, such as by being a solid material adhered to the solid electrolyte or two other anode materials which are in turn adhered to the solid electrolyte. In additional preferred embodiments, the anode active material can be a solid or other than solid (e.g. liquid) and can be captive within the anode region, such as by being trapped within pores of the porous region of the SSE.

In some embodiments, operation of the battery or other electrochemical system can occur at a temperature above the melting point of the anode active material by providing locating the anode active material within pores or other structure of the solid-state electrolyte, which serves to immobilize the anode active material to keep it in a location where the anode active material can participate in charge transfer reaction and be taken up by the solid-state electrolyte for conduction to the cathode (and returned to the anode during charging.)

In some preferred embodiments, anode active material can be or comprise lithium metal.

### Materials

In various embodiments, different types of materials can be used for the SSE and for the electrode which can then be subjected to rapid thermal annealing to improve the quality of the interface between the SSE and the electrode. In one embodiment, the electrode can be a cathode. Suitable cathode materials can comprise cathode active materials that comprise, consist of or consist essentially of lithium compound cathodes, such as VₓO_{y}/LiVₓO_{y}, LiCoO₂, LiMnO₂, LiNiO₂, LiNiₓMn_{y}Co₂O₂ (NMC), LiNiₓCo_{y}Al₂O₂(NCA), LiFePO₄, LiCoPO₄, LiMnPO₄, LiFeSO₄F, LiVPO₄F, LiFeMnO₄, sulfur-based cathodes (e.g. S, LiES), metal chalcogenide cathodes (e.g. TiS₃, NbSe₃, LiTiS₂), fluorine and chlorine compound cathodes (e.g. LiF cathode), lithium-oxygen and lithium-air cathodes, and cathodes containing combinations of these materials. In some embodiments, a cathode active material can comprise a layered oxide, a spinel, an olivine, a form of sulfur, a metal-sulfur compound, a lithium-containing sulfide, a sulfur-carbon complex, or a combination thereof. In some embodiments, a cathode material can comprise electrically conductive material, such as electrically conductive forms of carbon, such as carbon nanotubes, graphite, etc. In some embodiments, a cathode can be an air cathode, such as a Li-air cathode. In some embodiments, cathode active material can be combined with electrically conductive material in the cathode, such as by mixing, layering, intercalating, coating, etc.

In some embodiments, a metal anode can be used in combination with an SSE or with an SSE ionically connected to a cathode such as by a conformal interface as described herein. Suitable metal anodes can include Li metal anodes.

In some embodiments, an electrically conductive material can be present in the anode, such as a non-metal conductive material, such as electrically conductive carbon, such as carbon nanotubes, graphite, etc.

In various embodiments, the cathodes and cathode materials described herein can be combined with a SSE, such as by methods disclosed herein, and with any suitable anode or anode material. In various embodiments, anodes and anode materials described herein can be combined with a SSE, such as by methods disclosed herein, with any suitable cathode or cathode material.

Solid state electrolytes can comprise are generally ion conducting material that does not include a liquid phase. Suitable materials that can be used as or in a solid state electrolyte include crystalline oxides, amorphous oxides, sulfides, halides, solid polymers, and gels. In some embodiments, the solid state electrolyte (SSE) can have a garnet-like crystal form. In some embodiments, the SSE can be porous or non-porous, and porous SSE can have pores that are isolated from one another or interconnected to one another or a combination of isolated and interconnected. In some embodiments, the SSE can have a region that is porous and a region that is dense, where a dense region can be a non-porous region or a region that is less porous than the porous region (by percent open space or by pore size.) Suitable materials that can include a lithium-containing SSE material, a sodium-containing SSE material, or a magnesium-containing SSE material. A Li-garnet SSE material can be or comprise cation-doped Li₅La₃M¹₂O₁₂, where M¹ is Nb, Zr, Ta, or combinations thereof, cation-doped Li₆La₂BaTa₂O₁₂, cation-doped Li₇La₃Zr₂O₁₂, and cation-doped Li₆BaY₂M¹₂O₁₂, where cation dopants are barium, yttrium, zinc, or combinations thereof. A Li-garnet SSE material can also be or comprise Li₅La₃Nb₂O₁₂, Li₅La₃Ta₂O₁₂, Li₇La₃Zr₂O₁₂, Li₆La₂SrNb₂O₁₂, Li₆La₂BaNb₂O₁₂, Li₆La₂SrTa₂O₁₂, Li₆La₂BaTa₂O₁₂, Li₇Y₃Zr₂O₁₂, Li_{6.4}Y₃Zr_{1.4}Ta_{0.6}O₁₂, Li_{6.75}La_{2.75}Ca_{0.25}Zr_{1.5}Ta_{0.5}O₁₂, Li_{6.75}La₃Zr_{1.75}Ta_{0.25}O₁₂, Li_{6.75}BaLa₂Ta_{1.75}ZrO_{0.25}O₁₂, Li₆BaY₂M¹₂O₁₂, Li₇Y₃Zr₂O₂, Li_{6.75}BaLa₂Nb_{1.75}Zn_{0.25}SO₁₂, or Li_{6.75}BaLa₂Ta_{1.75}Zn_{0.25}O₁₂. A solid electrolyte can have a formula of Na₃₊ₓMₓZr₂₋ₓSi₂PO₁₂, wherein M is a metal ion selected from the group consisting of Al³⁺, Fe³⁺, Sb³⁺, and Yb³⁺, Dy³⁺, Er³⁺ and combinations thereof, where x is between 0.01 and 3, including all 0.01 values therebetween and ranges therebetween.

The electrodes, including the cathode, can be formed of particles bonded or sintered together to form a particulate electrode material or a particulate cathode material, where the particle structure can still be observed or determined. The electrodes, including the cathode, can also be in the form of a continuous layer, where the particulate nature has been lost, such as through processing or having not been present during processing or in the product. In some embodiments the electrode, including the cathode can have characteristics of particulate electrode material and a continuous layer.

The thickness of the cathode material on the SSE in the cathode-electrolyte construct can be any suitable thickness that provides sufficient cathode capacity, while also providing sufficient conductivity. In some embodiments, the thickness can be a millimeter or more. In some embodiments, the thickness can be 0.1-0.5 μm, 0.5-1 μm, 1-2 μm, 2-3 μm, 3-4 μm, 4-5 μm, 5-6 μm, 6-7 μm, 7-8 μm, 8-9 μm, 9-10 μm, 10-50 μm, 50-80 μm, 80-100 μm, 100-125 μm, 125-150 μm, 150-175 μm, 175-200 μm, 200-225 μm, 225-250 μm, 250-300 μm, 300-350 μm, 350-400 μm, 400-500 μm, 500-600 μm, 600-700 μm, 700-800 μm, 800-900 μm or 900-1000 μm.

### Thermal Treatment

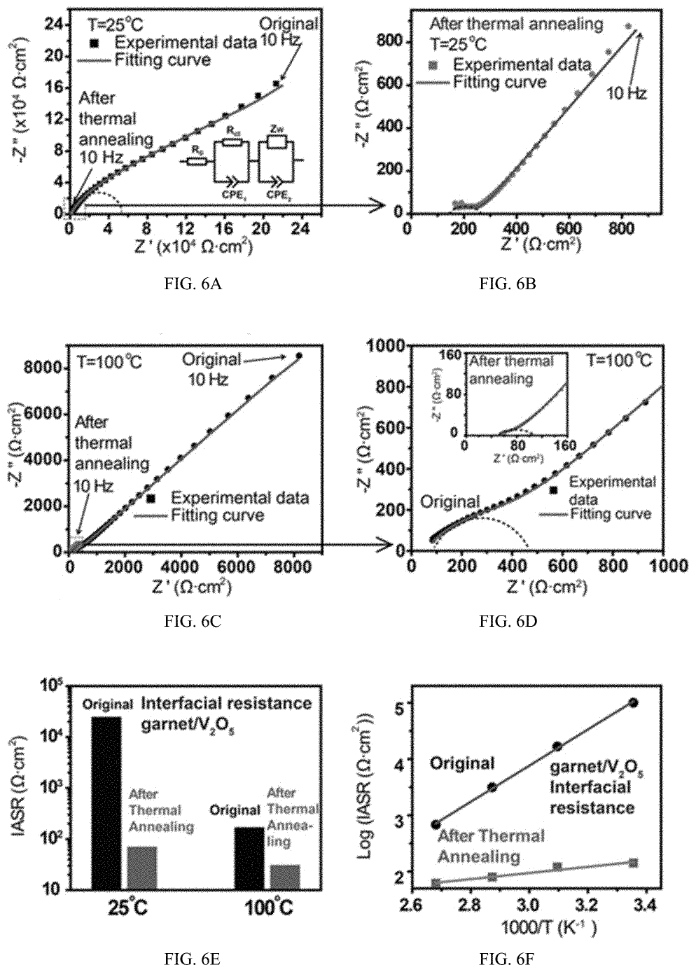

Rapid thermal annealing as discussed herein includes heating the materials sharing an interface rapidly to a temperature sufficient that upon cooling, the cathode will have conformed onto the surface of the SSE with fewer voids at the SSE-electrode (e.g. cathode) interface than prior to heating, and with a reduction in interfacial impedance at the SSE-cathode interface as compared to prior to heating. In some embodiments, the reduction in interfacial impedance can be such that the interfacial impedance after treatment will be 50% of the impedance prior to treatment, or 25%, 20%, 15%, 10%, 5%, 2%, 1%, 0.5%, 0.25% or 0.1% of the impedance prior to treatment. In some embodiments, the interfacial impedance after treatment can be 20, 100 or 150 Ω·cm² at a relevant temperature, such as a temperature of operation of the electrochemical system (such as a battery). Relevant temperatures can be 0, 10, 20, 25, 50, 100, 150, 200, 250, 300, 350, 400, 450, 500, 550, 600° C. or even higher or lower, depending on the particular materials being used in the electrode(s), electrolyte, current collector(s) and other portions of the electrochemical device (such as battery) and the conditions that the electrochemical system (such as battery) is exposed to. As shown in FIG. 6E, the IASR for some materials, including some solid electrolyte and electrode materials, can decrease with increasing temperature, facilitating use in electrochemical systems (such as batteries) at elevated temperatures, such as those discussed herein. In some embodiments, the interfacial impedance can be less than 20 Ω·cm² at a relevant temperature, such as 1 some value between 1 and 20 Ω·cm². In some embodiments the interfacial impedance can be less than 1 Ω·cm².

Various heating methods can be used, including but not limited to electric current activated/assisted sintering, Joule heating, combustion sintering, radiation heating, laser heating, plasma heating, microwave heating, combustion sintering, and flame heating (including gas flame, such as aerosol spray, heating) and combinations thereof. Various methods of cooling can also be used including electronic (such as by thermoelectric effect) conduction, convection, radiation and combinations thereof.

In some embodiments, the interfacial contact area of the treated interface can be 10%, 20%, 30%, 40%, 50%, 70%, 80%, 100%, 150%, 200%, 250%, or 300% higher than prior to treatment. In some embodiments, the interfacial contact area after treatment can have a value of 40%, 50%, 60%, 70%, 80%, or higher. In some embodiments, the heat treatment can take place with one or more heating steps. In one embodiment, the entire heating step can occur rapidly and at a constant rate or with a constant heat input. In some embodiments, the heat treatment can include two or more heating steps, such as where an initial heating step is faster, slower or at a similar/equivalent rate as or at a higher, lower or similar/equivalent heat input than a subsequent heating step. In some embodiments, an initial heating step can heat the materials sharing the interface to a temperature below where reaction, phase change or particle size growth of one or more of the materials sharing the interface becomes significant, and/or can or has potential to significantly affect impedance, stability or variability of the final interface. In some embodiments, a second heating step which follows the initial heating step can occur rapidly, such as where the time period for temperature rise, any optional holding time and then cooling to below a temperature where there is significant reaction, phase change or particle size growth takes less than 1 second, 1-1.5 seconds, 1.5-2 seconds, 2-3 seconds, 3-4 seconds, 4-5 seconds, 5-6 seconds, 6-8 seconds, 8-10 seconds, 10-15 seconds, 15-20 seconds, 20-30 seconds, 30-40 seconds, 40-50 seconds, 50-60 seconds, 60-70 seconds, 70-80 seconds or otherwise within a period less than time wherein a significant amount of reaction, phase change or particle size growth would occur. In some embodiments, the heating, optional hold and cooling can take place in a single step that takes takes less than 1 second, 1-1.5 seconds, 1.5-2 seconds, 2-3 seconds, 3-4 seconds, 4-5 seconds, 5-6 seconds, 6-8 seconds, 8-10 seconds, 10-15 seconds, 15-20 seconds, 20-30 seconds, 30-40 seconds, 40-50 seconds, 50-60 seconds, 60-70 seconds, 70-80 seconds or otherwise within a period less than time wherein a significant amount of reaction, phase change or particle size growth would occur.

In some embodiments, the cathode-electrolyte preform can be heated to a point that is above a sintering temperature of a component of the cathode, such as a sintering temperature of a cathode active material or another material in the cathode, and the time for the cathode-electrolyte preform (and/or the resulting cathode-electrolyte construct) at elevated temperature is sufficient to provide a conformal interface of the cathode-electrolyte construct. (“Sintering temperatures” is understood by one of skill in the art, and can be a temperature where adjacent particles subjected to the temperature fuse together or atoms/molecules from one particle migrate to an adjacent particle. In some embodiments, the sintering temperature for a material can be related to the melting point of the material, such as by being a fraction of the melting point. In some embodiments, the sintering temperature can be about 0.5-0.9× of the melting point (Celsius) or about 0.4-0.95× of the melting point (Celsius) or about 0.6-0.8× of the melting point (Celsius) or about 0.7-0.75× of the melting point (Celsius). In some embodiments, the sintering temperature can be above the melting point, provided a sufficiently short period of time of exposure to the temperature is used such that actual melting of the material does not occur to a significant extent.) In some embodiments, the time at or above the sintering temperature is sufficient to fuse particles of the electrode to one another and to the electrolyte. In some embodiments, the time at elevated temperature and/or the time at or above the sintering temperature can be limited such that particles of the cathode-electrolyte construct are not significantly larger than particles of the cathode-electrolyte preform. In some embodiments, the time at elevated temperature and/or at or above the sintering temperature can be limited such that diffusion of electrolyte species into the electrode or electrode species into the electrolyte or reaction of a component of the electrolyte or the electrode does not occur (for example, a component of the cathode or the electrolyte can react with itself, with another component of the cathode or electrolyte respectively, or with a component of the other of the cathode or electrolyte), does not occur to a significant extent (such as by impairing conductivity at least as much as the improvement to conductivity from formation of the conformal interface or by impairing conductivity by more than about 2%, 5%, 10%, 15% or 20%), or only occurs to within a layer up to 0.1, 0.2, 0.3, 0.4, 0.5, 0.6, 0.7, 0.8, 0.9 or 1 nm. In some embodiments, the time at elevated temperature and/or at or above the sintering temperature can be limited such that a phase change (such as the generation of a new phase or crystal form or a change from one phase or crystal form to another) does not occur, does not occur to a significant extent (such as by impairing conductivity at least as much as the improvement to conductivity from formation of the conformal interface or by impairing conductivity by more than about 2%, 5%, 10%, 15% or 20%), or only occurs to within a layer up to 0.1, 0.2, 0.3, 0.4, 0.5, 0.6, 0.7, 0.8, 0.9 or 1 nm. In some embodiments, the time at elevated temperature and/or at or above the sintering temperature can be limited such that a volume average particle size in the cathode-electrolyte construct is not more than 2%, 5%, 8%, 10%, 15%, 20%, 25%, 30%, 40%, or 50% larger in a diameter than a volume average particle size in the cathode-electrolyte preform. (When assessing the particle size of fused materials, the size of the constituent particles is considered.) In some embodiments, the heating step can cause one or more components of the cathode to melt, and in some such embodiments, upon re-solidification the cathode components will form particles having a volume average particle size that can be compared to the particle size of the cathode-electrolyte preform.

In some embodiments, the heating step can be up to a temperature less than the sintering temperature of any of the components of the cathode material, where phenomena such as differential expansion causes a consolidation of the electrode materials onto the surface of the electrolyte, forming a conformal interface.

### Product Structure

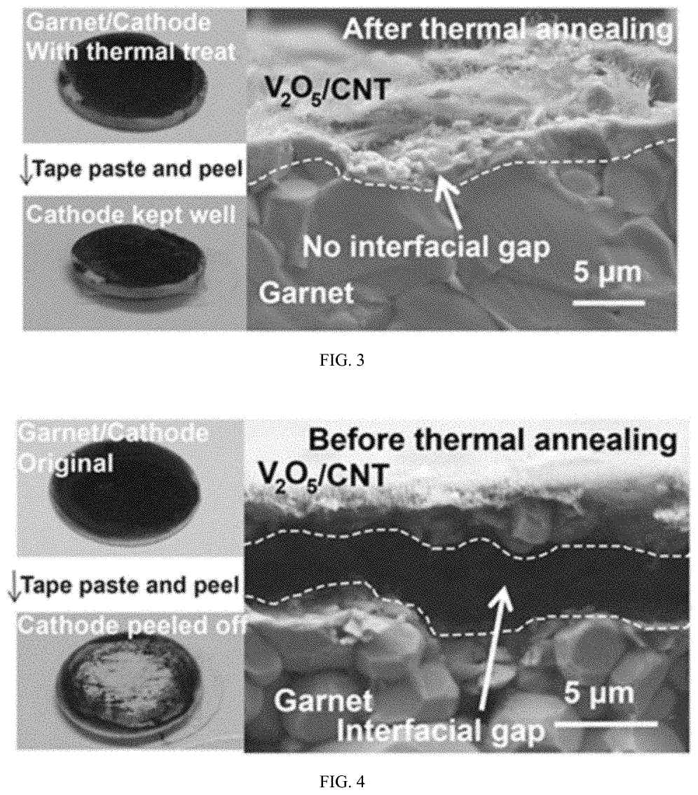

Conformal electrode-SSE interfaces, such as conformal cathode-SSE interfaces, such as those made by rapid thermal annealing including those disclosed herein can have an electrode, such as a cathode, which conformally covers the SSE. When conformally coated, the electrode can have significantly improved contact with the SSE and there can be a concurrent (and related) improvement in the conductance. In some embodiments, there can be an increase in conductivity of one or more orders of magnitude, such as 1, 2, 3, 4, 5, 6, 7 or more orders of magnitude improvement in conductance. Also, an improvement in the interfacial contact area of 1, 2, 3, 4, 5, 6, 7 or more orders of magnitude. In addition, the interface can be significantly reduced in (e.g. reduced by 10, 20, 30, 40, 50, 60, 70, 80, 90 or 95%) or substantially free of voids or gaps between the electrode and the SSE. (In evaluating the “conformalness” or “continuity” of the coating, it is recognized that solid particular structures contacting other solid structures, particulate or otherwise, will frequently, by their nature, create a series of point contacts. Voids or gaps in the contact would be extended regions where multiple successive particles have failed to be placed in contact with the other surface, rather than simply being blocked by an adjacent particle which is in contact.) An embodiment of a cathode conformally coating and SSE is shown in FIG. 3. Here, a garnet SSE is in contact with a cathode comprising V₂O₅ and carbon nanotubes (CNT). FIG. 3 shows the cathode contacting the SSE with no interfacial gap. In contrast, FIG. 4 shows a garnet SSE and a V₂O₅/CNT cathode prior to rapid thermal annealing and not having a conformal interface. Here, an interfacial gap is present between the SSE and the cathode. In materials with a non-conformal interfacial gap such as that of FIG. 4, there can be contact points between the SSE and the cathode at various locations of the interface, but gaps and voids are also present. Also shown in FIGS. 3 and 4 are views of the pictures of a garnet/cathode SSE-electrode before and after a tape peel test where the non-thermal processed material (FIG. 4) had substantial amounts of the cathode material peeled away while the thermal processed material (FIG. 3) had very little or no cathode material peeled away, demonstrating the additional structural integrity achieved by providing conformal contact between the SSE and the cathode.

Production of a conformally coated SSE-electrode, including those described herein, can include deposition techniques as well as other methods of layering cathode material onto a solid-state electrolyte. Layering methods can include various methods of applying paste or applying a green ceramic of the cathode material to the SSE. In some embodiments, and SSE can be slurry coated with the cathode material to form an electrode-electrolyte preform (or cathode-electrolyte preform). Additional embodiments include other techniques which result in a layer of cathode material on the SSE to form an electrode-electrolyte preform (or cathode-electrolyte preform). In some embodiments, processing steps can include pressing, filtration or other techniques for increasing contact between the SSE and the cathode material in producing the electrode-electrolyte preform (or cathode-electrolyte preform). In some embodiments, the cathode material can be dry or it can include a solvent or a binder. In some embodiments, the cathode material can be dried or desolventized before or after application to the SSE. Such methods can be advantageous over others, such as various deposition techniques (e.g. atomic layer deposition, sputtering, chemical deposition, etc.) which are slower to build up material, limited in that they can only apply a layer of a single material (as compared to other layering techniques which can apply one, two, three or more materials in a single layer), can include non-metal conductive materials (e.g. various forms of carbon such as carbon nanotubes, carbon black, graphite, etc.), can be applied inside of a structure (deposition techniques generally require line of sight for operation) and can result in application of particles as opposed to a film which can provide in some embodiments increased surface area and structural topography. In the embodiments shown in FIGS. 3 and 4, the cathode material was a combination of V₂O₅ and carbon nanotubes intermixed prior to application to the SSE. In various other embodiments, different cathode active materials, including those discussed herein, and different electrically conductive materials, including those discussed herein, can also be used in a similar fashion. In addition, as can be seen in FIG. 3, both the particulate nature of the V₂O₅ and the fibrous nature of the carbon nanotubes can be seen as being preserved in the final product. Accordingly, in some embodiments, the structural/shape characteristics of the cathode active material can be retained or can be changed in the structural/shape characteristics of the electrically conductive material can be retained or changed during the rapid thermal annealing process.

In some embodiments of rapid thermal annealing processes and products made therefrom, the cathode material in the electrode-electrolyte preform (or cathode-electrolyte preform) can be melted and then re-solidified upon cooling onto the surface of the SSE. In some embodiments, melting and re-solidification can result in formation of particles of cathode material in conformal contact with the SSE or can result in a sheet of cathode material in conformal contact with the SSE.

In some embodiments of rapid thermal annealing processes and products made therefrom, the cathode material of the electrode-electrolyte preform (or cathode-electrolyte preform) can be heated above the melting point, but for a sufficiently short time such that the cathode material (or one or more of its components) does not melt, only partially melts or only softens before being cooled to below the solidification point. In some embodiments, the rapid thermal annealing processes can result in a change in the particle size of the cathode material and/or the electrically conducting material, such as where the material is super-heated to at least some extent. In some such embodiments, the particle size can increase, and in some such embodiments, the particle size can decrease. In some embodiments, the rapid thermal annealing processes would occur sufficiently fast such that very little change in particle size of the cathode material and/or electrically conductive material. In some embodiments, the particle size of one or more components of the cathode can change less than 2%, 5%, 10%, 15%, 20%, 25%, 30% or 50%, including intervals between these values or more upon rapid thermal annealing processing.

### EXAMPLES

To quantify the effect of rapid thermal annealing on improving the garnet/cathode interfacial contact and reducing impedance, symmetric V₂O₅/garnet/V₂O₅ cells were prepared and tested by electrochemical impedance spectroscopy (EIS). The cells were assembled by coating cathode material and CNT current collectors on both sides of the garnet SSE and then applying the rapid thermal annealing. Symmetric cells with the same structure but not treated by the rapid thermal annealing process were also tested for comparison. The symmetric cell before thermal annealing does not show a clear arc for the interfacial impedance, because of the poor interfacial contact (FIG. 6A). Inset of FIG. 6A is the equivalent circuit of the symmetric cells, where R₀ is the bulk impedance including the impedances of garnet SSE and CNT current collectors, R_{ct} and CPE₁ (constant phase element) are the charge transfer resistance and double layer capacitance on the garnet/cathode interfaces, and Z_{w} and CPE₂ are for the diffusion impedance inside of V₂O₅ cathode, respectively. From equivalent circuit modeling, the R_{ct} before thermal annealing is 2.5×104 Ω·cm² for the cathode/garnet interface, whereas the R_{ct} after rapid thermal annealing dramatically decreases to 71 Ω·cm² (FIG. 6B), a 350 times decrease. The small impedance for an all-solid-state cathode/garnet interface is due to the good contact after rapid thermal annealing. Additionally, the diffusion impedance in the low-frequency region also decreases significantly after thermal annealing, as shown in FIG. 6A,B. The decrease of diffusion impedance is possibly due to the morphology change of V₂O₅ particles after rapid thermal annealing.

Synthesis of LLCZNO Garnet Solid-State Electrolyte.

The Li₇La₂Ca_{0.25}Zr_{1.75}Nb_{0.25}O₁₂ (LLCZNO) garnet powders were synthesized by a conventional solid state reaction. Stoichiometric amounts of LiOH.H₂O (Alfa Aesar, 98.0%), La₂O₃(Alfa Aesar, 99.0%), CaCO₃ (Alfa Aesar, 99.0%), ZrO₂ (Alfa Aesar, 99.0%), and Nb₂O₅(Alfa Aesar, 99.9%) were thoroughly ball milled in isopropanol for 24 h. Ten weight percent excess lithium salt was added to compensate lithium loss during the following heating processes. The mixed precursor powders were dried and calcined at 900° C. for 10 h in air. The calcined powder was ball-milled in isopropanol for 24 h. The dried powders were pressed into disks with diameter of 12.5 mm at 500 MPa and sintered at the temperature of 1050° C. for 12 h in air. Both precursor calcination and final sintering were carried out using alumina crucibles. Disks were embedded in mother powder to mitigate lithium losses at high sintering temperature. After sintering, the garnet disks were polished with sand paper to control the thickness to be ˜200 μm and produce smooth surface.

Preparation of V₂O₅/CNT Cathode Materials on Garnet. The V₂O₅ powders (99.6%, Sigma-Aldrich) and single wall carbon nanotubes (CNT) (Carbon Solutions) were dispersed in N-methyl-2-pyrrolidone (NMP) (Sigma-Aldrich) solvent with mass ratio 9:1 and total concentration 5 mg/mL. The particles in the solution were dispersed under ultrasonic for 4 h and then dropped on one side of garnet with pipettes. The amount of dropped solution was controlled to be 40 μL/cm² to achieve 0.2 mg/cm² cathode mass loading. After dropping, the solvent was evaporated at 150° C. on a hot plate to achieve the cathode/garnet combined structure. After drying up, 0.1 mg/cm² of CNT dispersed in NMP (5 mg/mL) was dropped on the top of cathode and dried to achieve current collectors. The thickness of the V₂O₅ cathode is around 2 μm.

Rapid Thermal Annealing of Cathode on Garnet.

The rapid thermal annealing device was made by suspending a rectangular piece of carbon paper (1 cm length, 0.8 cm width, and 250 μm thickness) on a glass substrate. The two ends of the carbon paper were connected to copper electrodes with conductive silver paste (SPI Supplies). Volteq HY6020EX power source was used to give electric current. The garnet SSE coated with cathode was put on the glass substrate, beneath the carbon paper. The rapid thermal annealing process was done in a glovebox filled with argon. The radiation spectrum was tested with an optical fiber detector (400 μm diameter) and analyzed with Ocean Optics software.

Characterizations.

The X-ray diffusion (XRD) phase test of garnet and cathode materials were done with a D8 Advanced system (Bruker AXS, WI, USA) using a Cu Kα radiation source operated at 40 kV and 40 mA. Cathode/garnet mixture for XRD test was composed of garnet, V₂O₅, and CNT powders with mass ratio 5:4:1. The Raman spectra of the garnet surface were tested by Horiba Jobin-Yvon Raman spectrometer with laser wavelength 532 nm. The morphologies of the interfaces and elemental mappings were tested with a field emission scanning electron microscope (FE-SEM, JEOL 2100F).

Assembly of Solid-State Batteries.

The blocking cells with garnet electrolyte for impedance test were made by coating Au paste on both sides of a garnet disk and heated at 800° C. for good contact. The V₂O₅/garnet/V₂O₅ symmetric cells were made by coating cathode on both sides of garnet and thermally treating either side in sequence. The garnet/cathode combinations after rapid thermal annealing were made into batteries by melting Li metal on the other side of the garnet disks. To improve contact between garnet and Li metal, one 10 nm thick layer of Si was coated on the lithium side of garnet, by plasma-enhanced chemical vapor deposition (PECVD) technique with Oxford Plasmalab System 100. After Si coating, Li metal was coated on garnet by melting and alloying with the Si, at 200° C. After this, the Li/SSE/cathode cells were assembled in CR2032 coin cell cases. The Li melting and cell assembly process were performed in a glovebox filled with Argon.

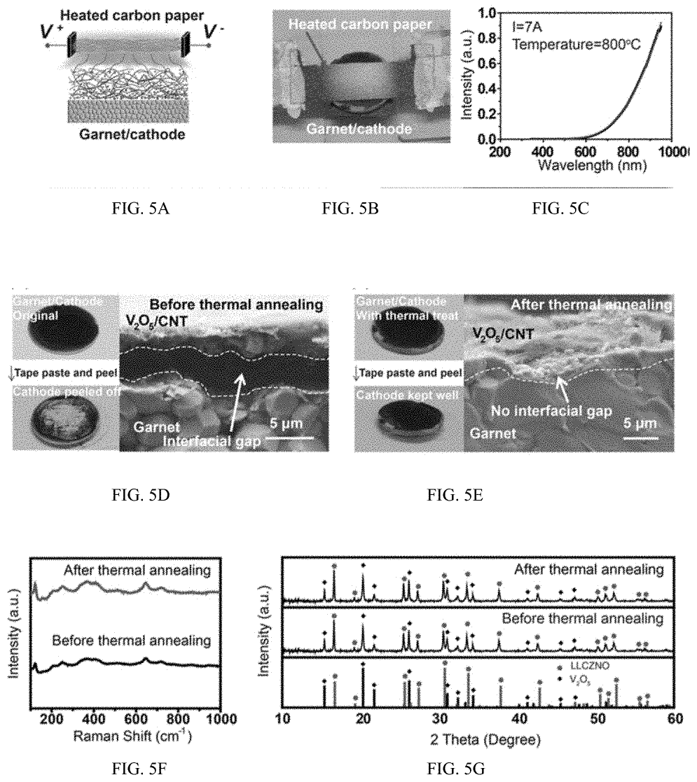

FIG. 5A, B shows a schematic and a photograph of the rapid thermal annealing device used to improve the contact at the garnet/cathode interface. Joule-heated carbon paper was used as a radiation heating source for the rapid thermal treatment, which can be heated up to high temperature within hundreds of milliseconds. The temperature of the carbon paper was controlled to be around 800° C., as calculated from the emission spectrum (FIG. 5C). V₂O₅ cathode was coated on garnet and put close to the high-temperature heating source for about 10 s for melting and wetting.

Electrochemical Tests.

The EIS tests and the cycling tests of the batteries were done with Bio-Logic tester. The test temperatures were controlled between room temperature and 100° C. by placing the batteries in a constant temperature chamber. EIS tests were performed with perturbation amplitudes 20 mV and over frequency range 1 MHz to 10 Hz. The battery cycling cut voltages were 1.2 to 4.5 V.

### Example—Summary of Results

After rapid thermal annealing, the contact between the V₂O₅ cathode and the garnet SSE is greatly improved as evidenced from peel-off experiments and cross-sectional SEM observations (FIG. 5D, E). Without thermal annealing, the cathode material can be easily detached from the garnet surface as shown in the left panel of FIG. 5D, because of the poor interfacial contact, as shown in the cross-sectional SEM images in the right panel of FIG. 5D. In contrast, after rapid thermal annealing, the cathode material remains well-adhered in equivalent peel-off tests due to the firm contact with the garnet surface as seen in the left panel of FIG. 5E. The crosssectional SEM image (right panel in FIG. 5E) of the garnet/cathode interface after rapid thermal annealing clearly demonstrates that the V₂O₅ material becomes small particles uniformly distributed and tightly integrated with the garnet surface. The morphology change occurs because V₂O₅ melts above 690° C. during the rapid thermal annealing up to 800° C. The melting of V₂O₅ results in good interfacial wetting with the garnet SSE and effectively improves the interfacial contact and decreases the impedance. This rapid thermal annealing technique is applicable for thin-film battery fabrication, as demonstrated herein. For some embodiments, such as some thin-film batteries, no solid-state electrolyte is mixed in the cathode, and ionic conduction in the cathode is provided by the V₂O₅ material. Because of the small thickness of the cathode after rapid thermal annealing, the conductivity of V₂O₅ is enough for operation at high temperatures.

Owing to the short annealing time, the garnet SSE and cathode materials remain chemically stable after the rapid thermal annealing process. The phase stability of garnet is proven by observing the Raman spectra of pure garnet before and after the rapid thermal annealing process (FIG. 5F). Both spectra show peaks in agreement with previously reported cubic phase garnet. The X-ray diffusion (XRD) patterns of mixed garnet powders, V₂O₅ powders, and CNT before and after rapid thermal annealing show the appropriate peaks without any impurities, further confirming the stability of V₂O₅ and garnet after the rapid thermal annealing (FIG. 5G). Note the CNT content (5%) is not high enough to show in the XRD pattern. The stability of garnet and V₂O₅ is further confirmed by energy-dispersive X-ray (EDX) elemental mappings. The EDX mappings show that vanadium stays within the cathode after the rapid thermal annealing process and does not diffuse into the garnet SSE.

To successfully operate at high temperature, we also measured the interfacial R_{ct} of garnet/V₂O₅ at 100° C., which decreases 5.5 times from 170 to 31 Ω·cm² between the symmetric cells processed without and with the rapid thermal treatment, respectively (FIG. 6C, D). The same test was also performed at 50 and 75° C. All the tests demonstrate a significant decrease in the interfacial R_{ct} and the cathode diffusion impedance after rapid thermal annealing, which indicates that the rapid thermal annealing process can effectively improve the garnet/cathode contact, enhance the diffusivity in V₂O₅ cathode and reduce the battery impedance. A summary of the improvement of the interfacial Rct before and after the rapid thermal annealing at different temperatures are given in FIG. 6E, F.

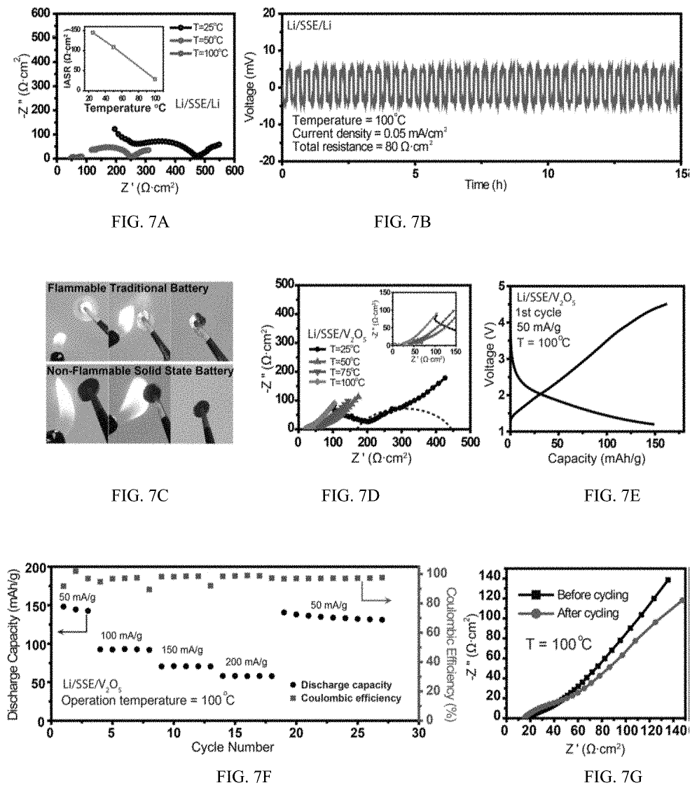

At the anode side, Li metal was melted on garnet SSE with a Si interface, with reaction between Li and Si for in situ formation of lithiated Si, resulting in improved wettability. To identify the interfacial impedance between the Li anode and garnet SSE as a part of the full cell impedance, Li/garnet/Li symmetric cells were tested by EIS at 25, 50, and 100° C. (FIG. 7A). From the EIS curves, the interfacial areal specific resistance (IASR) of the Li/garnet interface is calculated to be 150, 100, and 20 Ω·cm² at 25, 50, and 100° C., respectively. FIG. 6B is the voltage profile for galvanostatic cycling of the same Li/garnet/Li symmetric cell as shown in FIG. 6A During 15 h of galvanostatic cycling at 100° C., the total resistance is constant at 80 Ω·cm², which includes 8 Ω·cm² bulk resistance of garnet (calculated from the 2.4×10-3 S/cm conductivity at 100° C. and the 200 μm thickness of garnet). Therefore, the total interfacial impedance is 72 Ω·cm² that when divided by two is 36 Ω·cm² for each of the two garnet/Li interfaces. Another cell with the same structure was also cycled at 100° C., showing a more stable voltage profile over a longer period of time. The constant resistance during galvanostatic cycling indicates that the garnet SSE can cycle well with Li metal anodes at high temperatures with constant interfacial impedance because of the chemical and electrochemical stability of garnet against Li metal.

To further test the performance in a full cell configuration, the combination of V₂O₅ cathode and garnet SSE after rapid thermal annealing was assembled into all-solid-state batteries with a Li metal anode. FIG. 7C compares the flammability of a traditional battery with polymer separator to the all-solid-state battery with garnet SSE and a V₂O₅ cathode. The polymer separator in a traditional battery caught fire after a very short time span, whereas the all-solid-state battery with the garnet SSE and V₂O₅ cathode was stable under the same conditions.

This demonstrates the safety of the all-solid-state battery at high temperatures. FIG. 7D shows the EIS plots of the Li/garnet/V₂O₅ full cell tested at different temperatures (25, 50, 75, and 100° C.), where the bulk resistance, the interfacial RI and the diffusion impedance all decrease significantly as the operating temperature increases. The bulk resistance and the total interfacial RI decrease from 125 and ˜300 Ω·cm² at 25° C. to only 20 and 45 Ω·cm² at 100° C., respectively. The decreased interfacial charge transfer resistance is attributed to the stability and improved ionic conductivity of garnet SSE, the well-formed solid-state interface, and the high diffusivities of V₂O₅ at higher temperatures.

Operation or cycling of a Li/garnet/V₂O₅ battery can be limited at lower temperatures, including for some embodiments at room temperature because of the low diffusivity of Li⁺ in V₂O₅, which is increased at higher temperatures. The specific discharge capacity of the V₂O₅ cathode in the all-solid-state battery cycled at 100° C. is 150 mAh/g (FIG. 7E). For comparison, the battery without rapid thermal annealing shows a larger overpotential and a lower capacity (42 mAh/g) at 100° C. because of the poor contact between the garnet and cathode. Compared to V₂O₅/Li batteries with liquid electrolyte, the battery described above can have a lower average discharge voltage around 2 V. Without wishing to be bound by theory, this is believed to be due to the limited ion diffusion kinetics in the cathode of the all solid state battery, which results in a large polarization. The battery with rapid thermal annealing was cycled at 100° C. at current densities of 50, 100, 150, and 200 mA/g and recovered to 50 mA/g (FIG. 7F). After applying a high current density, the capacity returned to 150 mAh/g at the current density of 50 mA/g, which indicates that the cathode/garnet interface remains stable and reversible at current densities up to 200 mA/g. The >97% Coulombic efficiency during cycling indicates the good electrochemical stability of garnet SSE with the Li anode. The EIS plots of the battery before and after cycling further show that the interfacial R_{ct} is kept constant at about 50 Ω·cm², demonstrating the stability of the garnet/cathode and garnet/Li interfaces during high-temperature cycling (FIG. 7G).

### Example—Comparison to Slow Heat Treatment

A process control experiment has been performed by using conventional furnace annealing. A powder mixture of garnet, V₂O₅, and CNT was heated up to 800° C. in argon atmosphere at a rate of 30° C./min. This is slower than the rapid thermal annealing method described herein, which in some embodiments reaches the same temperature in 1 s. With such a slow heating ramp, black smoke was observed billowing out of the powder mixtures at 420° C., most likely due to the CNT oxidation by V₂O₅. This establishes that there are undesirable reactions between these materials at slowly elevated temperatures that precludes the use of furnace sintering to improve the garnet/cathode interface. Therefore, in contrast to conventional heating methods, the rapid thermal annealing such as by radiation heating, averts significant side reactions between the cathode materials and solid-state electrolyte while improving the interfacial contact.

Accordingly, rapid thermal annealing can be used to achieve a solid state electrochemical system, such as a battery, with solid cathode and solid SSE with stable electrochemical performance and high efficiency. The rapid thermal annealing process described herein can in some embodiments effectively address instances of high interfacial impedance between the cathode and solid-state electrolyte while keeping both materials chemically stable. The resulting cathode/SSE interfacial impedance in one embodiment was shown to decrease from 2.5×104 to 71 Ω·cm² at room temperature and from 170 to 31 Ω·cm² at 100° C., respectively. The diffusion impedance inside of the cathode material significantly decreases as well. One embodiment of a battery has a small and stable interfacial impedance of 45 Ω·cm², exhibits >97% Coulombic efficiency, and maintains a stable discharge capacity at 100° C. Accordingly, rapid thermal annealing provides a method and resulting structures with reduced interfacial impedance between cathode and solid state electrolyte and also demonstrates SSE can be used in solid-state batteries, including solid state batteries for use at elevated temperatures.

In addition, the methods disclosed herein, including rapid thermal annealing, can enable different types of electrodes to be applied in solid-state battery architectures, can enable truly all-solid-state batteries, without any liquid or polymer inside, with high stability and safety, can enable all-solid-state batteries with high thermal stability, for high temperature applications. can facilitate the development of solid-state Li metal batteries, Li ion batteries, Li-sulfur batteries, and Li-air batteries, which have much higher energy density and are much safer than conventional batteries, and can enable the application of high voltage cathode materials at least by facilitating use of the wide electrochemical stability window (0˜5V vs. Li+/Li) of solid-state electrolyte.

As used herein, the words “approximately”, “about”, “substantially”, “near” and other similar words and phrasings that indicate variations from an absolute value are to be understood by a person of skill in the art as allowing for an amount of variation not substantially affecting the working of the device, example or embodiment. In those situations where further guidance is necessary, the degree of variation should be understood as being 10%.

Having now described the invention in accordance with the requirements of the patent statutes, those skilled in this art will understand how to make changes and modifications to the present invention to meet their specific requirements or conditions. Such changes and modifications may be made without departing from the scope and spirit of the invention as disclosed herein.

The foregoing Detailed Description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation. The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom. Applicant has made this disclosure with respect to the current state of the art, but also contemplates advancements and that adaptations in the future may take into consideration of those advancements, namely in accordance with the then current state of the art. It is intended that the scope of the invention be defined by the Claims as written and equivalents as applicable. Reference to a claim element in the singular is not intended to mean “one and only one” unless explicitly so stated. Moreover, no element, component, nor method or process step in this disclosure is intended to be dedicated to the public regardless of whether the element, component, or step is explicitly recited in the Claims.

1. A cathode-electrolyte construct comprising:
a solid state electrolyte; and
a cathode comprising particulate cathode material, the cathode conformally contacts the solid state electrolyte.

2. The cathode-electrolyte construct of claim 1, wherein the particulate cathode material comprises a first and a second material, the first and second materials different from one another, and particles of the first material are intermixed with particles of the second material.

3. The cathode-electrolyte construct of claim 2, wherein particles of the first material contact the solid state electrolyte and particles of the second material contact the solid state electrolyte.

4. The cathode-electrolyte construct of claim 2, wherein the first material is an electrically conductive material and the second material comprises a cathode active material.

5. The cathode-electrolyte construct of claim 4, wherein the electrically conductive material comprises a carbon material.

6. The cathode-electrolyte construct of claim 5 wherein the carbon material is carbon nanotubes.

7. The cathode-electrolyte construct of claim 4, wherein the cathode active material is selected from the group consisting of layered oxide, spinel, olivine, sulfur, metal-sulfur compounds, lithium-containing sulfides, and sulfur-carbon complexes.

8. The cathode-electrolyte construct of claim 1, wherein the particulate cathode material forms a layer on the solid state electrolyte, the layer having a thickness of 0.1-500 μm.

9. The cathode-electrolyte construct of claim 1, wherein conformal contact between the cathode and the solid state electrolyte is substantially free of voids.

10. A solid state battery comprising:
the cathode-electrolyte construct of claim 1;
a cathode current collector;
an anode; and
an anode current collector,
wherein the cathode current collector is in electrical communication with the particulate cathode material, the anode is in ionic communication with the solid state electrolyte, and the anode current collector is in electrical communication with the anode, and
the solid state battery is configured for ions to flow from the anode, through the solid state electrode to the particulate cathode material when electrons flow through an external circuit from the anode current collector to the cathode current collector.

11. The solid state battery of claim 10, wherein the cathode current collector contacts the particulate cathode material, and the anode contacts both the solid-state electrolyte and the anode current collector.

12. A method of making the cathode-electrolyte construct of claim 1 comprising:
applying the particulate cathode material to the solid-state electrolyte to form a cathode-electrolyte preform; and
heating the cathode-electrolyte preform to a temperature exceeding a sintering temperature of a component of the particulate cathode material for a period of time that is less than a time necessary for reaction or a change of phase of a component of the cathode or electrolyte to extend beyond 0.5 nm of the interface; and
cooling the heated cathode-electrolyte preform to yield the cathode-electrolyte construct.

13. The method of claim 12, wherein the particulate cathode material comprises a first material and a second material, the first and second materials different from one another, and particles of the first material are intermixed with particles of the second material.

14. The method of claim 12, wherein the particulate cathode material comprises a first and a second material, the first material is an electrically conductive material and the second material comprises a cathode active material.

15. The method of claim 14, wherein the electrically conductive material comprises a carbon material.

16. (canceled)

17. The method of claim 14, wherein the cathode active material is selected from the group consisting of layered oxide, spinel, olivine, sulfur, metal-sulfur compounds, lithium-containing sulfides, and sulfur-carbon complexes.

18. The method of claim 12, wherein the cathode-electrolyte preform is heated to a temperature that is within a range of 0.5 to 0.9× of a melting point in Celsius of a component of the cathode.

19. The method of claim 12, wherein a time for heating, cooling and optionally holding at an elevated temperature is less than 60 seconds.

20. A high-temperature battery comprising:
a solid state electrolyte;
a solid cathode comprising a solid cathode active material and a cathode current collector;
an anode comprising a captive anode active material and an anode current collector,
wherein the high temperature battery is configured to operate at a temperature in excess of 90° C.

21. (canceled)

22. (canceled)

23. (canceled)

24. (canceled)

25. (canceled)

26. (canceled)

27. (canceled)

28. A method of operating a battery comprising:
exposing a battery to a temperature in excess of 100° C.;
discharging or charging the battery, wherein discharging the battery comprises the steps of:
oxidizing an anode active material at an anode to release one or more electrons and form a cation;
conducting the cation from the anode active material into a solid-state electrolyte;
conducting the cation through the solid-state electrolyte to a cathode; and
accepting one or more electrons from the anode into the cation at the cathode to form a reduced material; and
charging the battery comprises the steps of
removing one or more electrons from the reduced material at the cathode to form the cation;
conducting the cation from the cathode active material into the solid-state electrolyte; conducting the cation through the solid-state electrolyte to the anode; and
adding the one or more electrons from the cathode into the cation at the anode to form the anode active material.

29. (canceled)

30. (canceled)

31. (canceled)

32. (canceled)

33. (canceled)

34. (canceled)

35. (canceled)

36. (canceled)

37. (canceled)
